(19) United States
(12) Patent Application Publication
(10) Pub. No.: US 2022/0359185 A1
(43) Pub. Date: Nov. 10, 2022

(54) CHEMICAL IONISATION METHOD AND ION MOLECULE REACTOR

(71) Applicant: TOFWERK AG, Thun (CH)

(72) Inventor: Felipe LOPEZ-HILFIKER, Steffisburg (CH)

(73) Assignee: TOFWERK AG, Thun (CH)

(21) Appl. No.: 17/739,870

(22) Filed: May 9, 2022

(30) Foreign Application Priority Data
May 10, 2021 (EP) 21 173 162.5

(51) Int. Cl. H01J 49/14

(52) U.S. Cl. CPC H01J 49/145

(57) ABSTRACT

The invention relates to a chemical ionisation method, in particular an adduct ionisation method, for ionising a sample including analytes to be ionised, wherein ligand compound ions formed from reactant ions and a dopant substance are made available in a reaction volume (2), wherein said sample with said analytes is introduced into said reaction volume (2) to react with said ligand compound ions to form adduct ions and a neutral byproduct, said adduct ions including ionised analytes being adducts of said reactant ions and the respective said analytes, wherein said reactant ions and said dopant substance provide a higher binding energy when binding together to said ligand compound ions than a binding energy said reactant ions and a ligand forming substance provide when binding together, wherein said ligand forming substance is present at least in traces in said reaction volume (2) when said sample with said analytes react with said ligand compound ions to form said adduct ions and said neutral byproduct. Furthermore, the invention relates to An ion molecule reactor (1) for ionising a sample including analytes to be ionised with the chemical ionisation method according to one of claims 1 to 11, in particular for use with a mass spectrometer (100), including: a reaction volume (2) adapted for ionising inside said reaction volume (2)said sample including said analytes to be ionised by chemical ionisation, in particular adduct ionisation, wherein inside of said reaction volume (2) ligand compound ions formed from reactant ions and a dopant substance can be made available to react with said sample including said analytes to form adduct ions and a neutral byproduct, said adduct ions including ionised analytes being adducts of said reactant ions and the respective said analytes, at least one sample inlet (4) for introducing said sample including said analytes into said reaction volume (2); at least one reactant inlet (5, 6) for introducing at least one substance into said reaction volume (2) for making said ligand compound ions available inside said reaction volume (2); and an outlet (7) for letting out said adduct ions from said reaction volume (2).

### TECHNICAL FIELD

The invention relates to a chemical ionisation method, in particular an adduct ionisation method, for ionising a sample including analytes to be ionised. Furthermore, the invention relates to an ion molecule reactor for ionising a sample including analytes to be ionised with the method according to the invention.

### BACKGROUND ART

Mass spectrometry is an analytical technique which is widely used in many different fields of technology for the identification and quantification of individual substances or compounds of interest in pure samples as well as in samples being complex mixtures which include the individual substances or compounds of interest as well as other substances which are not required to be identified and quantified and are thus substances of no further interest. Thereby, the individual substances and compounds of interest are often referred to with the umbrella term “analytes”.

Mass spectrometry usually involves the measurement of the mass-to-charge ratio of ionised analytes or analyte ions, respectively. Thus, in a first step, the analytes in the sample, which are typically neutral atoms or molecules, need to be ionised and transferred to a mass analyser. Thereby, chemical ionisation is particularly advantageous because this technique results in minimal fragmentation of the analytes as well as a high degree of preservation of molecular identity and structure of the analytes.

In chemical ionisation, ionised analytes are produced in a reaction volume of an ion molecule reactor through collisions of the analytes with reactant ions. These reactant ions typically have been produced in a reactant ion source and are sometimes also referred to as primary ions. In the reactant ion source, the reactant ions can be created from a reactant being in a solid, liquid or gaseous aggregate state. In operation, the reactant ion source ionises the reactant for example by electron ionisation, electromagnetic radiation like x-rays or UV radiation, or radioactive radiation to the reactant ions.

Chemical ionisation ion sources which rely on adduct ionisation follow the general reaction scheme where a reactant ion combines with an analyte to an adduct ion. The optimum sensitivity of such a chemical ionisation ion source is usually achieved at elevated pressures to maximise the collision frequency of reactant ions and analytes. However, often, the sample not only includes the analytes but also includes at least one ligand forming substance which tends to form ligand ions with the reactant ions. Also, traces of such a ligand forming substance may be present in the chemical ionisation ion source from a previously ionised sample. Thus, whenever such a ligand forming substance is present in the reaction volume when the reactant ions and the sample with the analytes are introduced into the reaction volume for ionising the analytes, the reaction volume not only comprises pure reactant ions but also comprises ligand ions formed of one or more molecules of the ligand forming substance bonded to a reactant ion. Each such ligand ion may as well react with an analyte and form an adduct ion and some neutral byproduct, wherein the adduct ion consists of the respective analyte and the reactant ion of the respective former ligand ion, while the neutral byproduct may for example be one or more molecules of the ligand forming substance. However, in most cases, the likelihood that a pure reactant ion colliding with a particular analyte reacts to form an adduct ion differs strongly, sometimes even in the order of one or more magnitudes, from the likelihood that a ligand ion colliding with the same particular analyte reacts to from an adduct ion and some neutral byproduct. Thereby, the likelihood that a particular ligand ion formed from a particular reactant ion and a particular ligand forming substance colliding with one particular analyte reacts to form an adduct ion and some neutral byproduct may be increased as compared to the likelihood that the pure respective particular reactant ion colliding with the respective particular analyte reacts to form an adduct ion. At the same time, the likelihood that the respective particular ligand ion formed from the respective particular reactant ion and the respective particular ligand forming substance colliding with another particular analyte reacts to form an adduct ion and some neutral byproduct may be decreased as compared to the likelihood that the pure respective particular reactant ion colliding with the respective particular other analyte reacts to form an adduct ion.

Already small changes in the partial pressure of the ligand forming substance in the reaction volume may shift the ratio of pure reactant ions to ligand ions formed from one of the reactant ions and the ligand forming substance present in the reaction volume. Thus, already small changes in the partial pressure of the ligand forming substance in the reaction volume may lead to completely different ionisation efficiencies of the chemical ionisation ion source for different analytes. Consequently, small changes in the partial pressure of the ligand forming substance in the reaction volume may disable the ability to quantify or even to identify the analytes in the sample with mass spectrometry.

In case iodide ions (I⁻) are used as reactant ions, water may be such a ligand forming substance. Such an example is described in the publication “Flight Deployment of a High-Resolution Time-of-Flight Chemical Ionization Mass Spectrometer: Observations of Reactive Halogen and Nitrogen Oxide Species” of Ben H. Lee et al. in the Journal of Geophysical Research: Atmospheres, Volume 123, Issue 14, 27 Jul. 2018, pages 7670-7686. In the investigation described in this publication, analytes present in the atmosphere have been mass analysed. Since it was known that the water content in the atmosphere may change dramatically from air layer to air layer and may also change with changing weather, it was known that water acts as a ligand forming substance which can change considerably the ionisation efficiencies of the chemical ionisation ion source for the different analytes. Even more, the publication specifies that the sensitivity of iodide□adduct ionisation to many compounds is influenced by the absolute water vapour concentration in the ion molecule reactor, often changing rapidly near dry conditions, and more gradually under humid conditions. The publication further mentions that this effect is most problematic when assessing instrumental backgrounds using dry ultra high pure N₂ since the sensitivity between ambient and background determinations will change. In order to tackle this issue, the publication teaches to reduce the effects of ambient humidity variations and of changes between the ambient and background determinations by continuously adding a flow of ultra high pure N₂ of 100 sccm saturated in water vapour to the ion molecule reactor, resulting in at least 0.15 torr of water vapour pressure (comparable to measuring an ambient relative humidity of about 15% relative humidity at 0 C or an ambient relative humidity of about 60% relative humidity or 20 C) in the ion molecule reactor at all times. Thereby, in the present text, the units “sccm” are standard cubic centimetres per minute at a temperature of 298.15 K and at a gas pressure of 101.300 kPa.

Thus, the approach described the publication is to continuously add some of the ligand forming substance to the reaction volume to achieve and maintain in the reaction volume a certain minimal partial gas pressure of the ligand forming substance, the minimal partial gas pressure being in a range where the sensitivity of reactant ion□adduct ionisation to many compounds shifts more gradually when the amount of ligand forming substance in the sample changes. This improves the quantitative results of the mass analysis of the analytes in the sample to some extent. Nonetheless, it is still very difficult to precisely and reliably quantify the analytes in the sample with mass spectrometry.

### SUMMARY OF THE INVENTION

It is the object of the invention to create a chemical ionisation method, in particular an adduct ionisation method, and an ion molecule reactor pertaining to the technical field initially mentioned, that enable a more precise and more reliable quantification of the analytes in the sample with mass spectrometry.

The solution of the invention is specified by the features of claim 1. According to the invention, ligand compound ions formed from reactant ions and a dopant substance are made available in a reaction volume. Furthermore, the sample with the analytes is introduced into the reaction volume to react with the ligand compound ions to form adduct ions and a neutral byproduct, the adduct ions including ionised analytes being adducts of the reactant ions and the respective analytes. Thereby, the reactant ions and the dopant substance provide a higher binding energy when binding together to the ligand compound ions than a binding energy the reactant ions and a ligand forming substance provide when binding together, wherein the ligand forming substance is present at least in traces in the reaction volume when the sample with the analytes react with the ligand compound ions to form the adduct ions and the neutral byproduct.

As mentioned, according to the invention, the sample with the analytes is introduced into the reaction volume to react with the ligand compound ions to form adduct ions and a neutral byproduct, the adduct ions including the ionised analytes being adducts of the reactant ions and the respective analytes. Thus, the analytes to be ionised are ionised with the method according to the invention.

For the solution according to the invention, it is irrelevant, whether the ligand compound ions are made available in the reaction volume before the sample with the analytes is introduced into the reaction volume to react with the ligand compound ions to form adduct ions and the neutral byproduct, whether the ligand compound ions are made available in the reaction volume at the same time as the sample with the analytes is introduced into the reaction volume to react with the ligand compound ions to form adduct ions and the neutral byproduct or whether the ligand compound ions are made available in the reaction volume after the sample with the analytes is introduced into the reaction volume to react with the ligand compound ions to form adduct ions and the neutral byproduct. Advantageously, however, the ligand compound ions are made available in the reaction volume continuously while the sample with the analytes is introduced into the reaction volume to react with the ligand compound ions to form adduct ions and the neutral byproduct. By continuously providing the ligand ions in the reaction volume as the sample is inserted into the reaction volume for being ionised, a stable and reproducible ionisation of the sample and the analytes can be achieved in a simple manner.

According to the invention, the reactant ions and the dopant substance provide a higher binding energy when binding together to the ligand compound ions than the binding energy the reactant ions and the ligand forming substance provide when binding together. Thus, the ligand forming substance differs from the dopant substance. Particular advantageously, the chemical ionisation method includes the preliminary step of choosing at least one of the reactant ions and the dopant substance such that the reactant ions and the dopant substance provide a higher binding energy when binding together to the ligand compound ions than the binding energy the reactant ions and the ligand forming substance provide when binding together. Thus, in a first preferred variant, the chemical ionisation method includes the preliminary step of choosing the dopant substance such that the dopant substance provides a higher binding energy when binding together with the reactant ions to the ligand compound ions than the binding energy the reactant ions and the ligand forming substance provide when binding together. In a second preferred variant however, the chemical ionisation method includes the preliminary step of choosing the reactant ions such that they provide a higher binding energy when binding together with the dopant to the ligand compound ions than the binding energy the reactant ions and the ligand forming substance provide when binding together. In a third preferred variant, however, the chemical ionisation method includes the preliminary step of choosing the reactant ions and the dopant substance such that the reactant ions provide a higher binding energy when binding together with the dopant to the ligand compound ions than the binding energy the reactant ions and the ligand forming substance provide when binding together. Alternatively, however, the method may go without such a preliminary step of choosing at least one of the reactant ions and the dopant substance.

According to the invention, the ligand forming substance is present at least in traces in the reaction volume when the sample with the analytes react with the ligand compound ions to form the adduct ions and the neutral byproduct. Thereby, the reason why the ligand forming substance is present in the reaction volume is irrelevant. For example, the ligand forming substance can have been introduced into the reaction volume during maintenance of the reaction volume, during a previous ionisation of a previous sample because it was part of the respective previous sample or it can be introduced into the reaction volume because it is part of the sample being currently ionised.

For the solution according to the invention, it is irrelevant how the ligand compound ions are made available in the reaction volume. In a first variant, the ligand compound is provided first and then ionised to the ligand compound ions and these ligand compound ions are made available in the reaction volume. Advantageously, however, the reactant ions are provided and the dopant substance is brought into reaction with the reactant ions to form the ligand compound ions with the reactant ions for making the ligand compound ions available in the reaction volume. This has the advantage that the ligand compound ions can easily be adapted and provided in the reaction volume by providing the reactant ions and choosing the dopant substance according to the requirements of the sample and analytes and the ligand forming substance such that the reactant ions and the dopant substance provide the higher binding energy when binding together to the ligand compound ions than the binding energy the reactant ions and the ligand forming substance provide when binding together.

The solution of the invention is furthermore an ion molecule reactor for ionising a sample including analytes to be ionised with the chemical ionisation method according to the invention, in particular for use with a mass spectrometer. This ion molecular reactor includes a reaction volume adapted for ionising inside the reaction volume the sample including the analytes to be ionised by chemical ionisation, in particular adduct ionisation, wherein inside of the reaction volume ligand compound ions formed from reactant ions and a dopant substance can be made available to react with the sample including the analytes to form adduct ions and a neutral byproduct, the adduct ions including ionised analytes being adducts of the reactant ions and the respective analytes. Advantageously, this reaction volume is defined by a chamber of the ion molecule reactor. The reaction volume may however as well be defined by more than one chambers of the ion molecule reactor or may be defined otherwise. Independent of how the reaction volume is defined, the ion molecule reactor includes at least one sample inlet for introducing the sample including the analytes into the reaction volume and at least one reactant inlet for introducing at least one substance into the reaction volume for making the ligand compound ions available inside the reaction volume. Furthermore, the ion molecule reactor includes an outlet for letting out the adduct ions from the reaction volume.

In a first preferred variant, the at least one reactant inlet is for introducing the ligand compound ions and possible individual reactant ions and dopant substance into the reaction volume or for introducing a ligand compound into the reaction volume for being ionised to the ligand compound ions inside the reaction volume. Thus, in this latter case, the ion molecule reactor advantageously includes a ligand compound ion ion source for ionising the ligand compound to ligand compound ions inside the reaction volume.

In a second preferred variant, the at least one reactant inlet is for introducing a reactant into the reaction volume for being ionised to the reactant ions inside the reaction volume. Thus, in this second preferred variant, the ion molecule reactor advantageously includes a reactant ion ion source for ionising the reactant to reactant ions inside the reaction volume. In a first variation of the second preferred variant, the at least one reactant inlet is for introducing the dopant substance into the inside of the reaction volume, too. In a second variation of the second preferred variant, however, the at least one reactant inlet are two reactant inlets, wherein a first one of the two reactant inlets is for introducing the reactant into the reaction volume to be ionised in the reaction volume to the reactant ions, while a second one of the two reactant inlets is for introducing the dopant substance into the reaction volume.

In a third preferred variant, the at least one reactant inlet are two reactant inlets, wherein the first one of the two reactant inlets is for introducing the reactant ions into the reaction volume, while the second one of the two reactant inlets is for introducing the dopant substance into the reaction volume.

Thus, in both the second variation of the second preferred variant and in the third variant, the at least one reactant inlet are two reactant inlets. Consequently, in order to cover both the second variation of the second variant and the third variant, advantageously, the at least one reactant inlet for introducing at least one substance into the reaction volume are to reactant inlets for introducing two substances into the reaction volume for making the ligand compound ions available inside the reaction volume.

It was found out that surprisingly, when making the ligand compound ions available in the reaction volume and ensuring that the reactant ions and the dopant substance provide the higher binding energy when binding together to the ligand compound ions than the binding energy the reactant ions and the ligand forming substance provide when binding together, the dopant substance binds to the reactant ions and even replaces ligand forming substance already bound to reactant ions and thus occupies the reactant ions. Therefore it was found out, that by providing the ligand compound ions in the reaction volume, changes in the partial pressure of the ligand forming substance in the reaction volume do not shift the ratio of pure reactant ions to ligand ions from one of the reactant ions and the ligand forming substance present in the reaction volume any longer. Consequently, the ionisation efficiencies of the chemical ionisation ion source for the different analytes remains constant even when the partial pressure of the ligand forming substance in the reaction volume changes. Therefore, a more precise and more reliable quantification of the analytes in the sample with mass spectrometry is enabled.

Advantageously, the reactant ions are provided by generating the reactant ions in the reaction volume or by introducing the reactant ions into the reaction volume. In the latter case, the reactant ions are advantageously generated by a reactant ion ion source outside of the reaction volume and transferred into the reaction volume.

Advantageously, the dopant substance is brought into reaction with the reactant ions to form the ligand compound ions with the reactant ions in the reaction volume. This is advantageous in case the reactant ions are provided by generating the reactant ions in the reaction volume as well as in case the reactant ions are introduced into the reaction volume. In case the reactant ions are introduced into the reaction volume, the dopant substance is brought into reaction with the reactant ions to form the ligand compounds with the reactant ions in the reaction volume and/or outside the reaction volume before being introduced into the reaction volume. In either of these cases, ultimately, the ligand compounds are made available in the reaction volume.

Advantageously, the ligand compound ions have a same charge as the reactant ions. This has the advantage that the ionised analytes being adducts of the reactant ions and the respective analyte provide a known and well controllable charge. Alternatively, however, the ligand compound ions have a different charge than the reactant ions.

According to the invention, the sample includes analytes to be ionised. These analytes are advantageously substances or compounds of interest. Thus, in an advantageous variant, before ionising the sample including the analytes to be ionised, specific substances, specific compounds, classes of substances and/or classes of compounds are identified as being of interest and thus as being the analytes to be ionised. This has the advantage that an optimised targeted analysis of the sample is enabled. Alternatively, however, this preliminary step identifying the analytes to be ionised is omitted.

Advantageously, the sample includes at least traces of the ligand forming substance. Thereby, the sample advantageously includes the at least traces of the ligand forming substance and the analytes to be ionised, wherein the ligand forming substance differs from the analytes to be ionised. Thus, the sample does not consist of the ligand forming substance only but comprises at least one analyte to be ionised, too.

In case the sample includes at least traces of the ligand forming substance, preferably, the sample consists of parts, wherein the parts are atoms or molecules, and wherein a concentration of the parts of ligand forming substance in the total parts of the sample varies at a rate of at least 10% of the initial concentration of the parts of ligand forming substance in the total parts of the sample within one hour, particular preferably within one minute, most preferably within one second. In a variant however, the concentration of the parts of ligand forming substance in the total parts of the sample does not vary with at least 10% of the initial concentration of the parts of ligand forming substance in the total parts of the sample within one hour.

In case the sample includes at least traces of the ligand forming substance, the sample preferably consists of parts and includes at least one part, in particular at least one molecule, of the ligand forming substance per 10′000′000 parts, particular preferably per 100′000 parts, most preferably per 1′000 parts of the sample, wherein the parts are atoms or molecules.

Alternatively, however, the sample does not include the ligand forming substance. In this alternative, the ligand forming substance is advantageously present in the reaction volume for other reasons as described further above.

Preferably, the ligand forming substance is one of water, ethanol, benzene, nitric acid and acetic acid or is any other molecule containing an acid, peroxide, alcohol or ketone moiety. Particular preferably, the ligand forming substance is water because water reacts with reactant ions and because water is often included in varying amounts in samples including analytes to be ionised. As initially mentioned, water can be for example the ligand forming substance in case analytes in the atmosphere are to be mass analysed and in particular in case the reactant ions are iodide ions (I⁻). On the other hand, acetic acid is the ligand forming substance in case malonic acid or nitric acid are to be mass analysed and quantified and are thus the analytes to be ionised.

Alternatively, however, the ligand forming substance is another substance than water, ethanol, benzene, nitric acid and acetic acid and is not a molecule containing an acid, peroxide, alcohol or ketone moiety.

Preferably, the reactant ions are one of I⁻, Br⁻, Cl⁻, CF₃O⁻, NO₃⁻, acetate⁻, NO⁺, NH₄⁺, amine⁺, acetone⁺, ethanol⁺, H₃O⁺ and benzene⁺. This has the advantage that reactant ions can easily be provided in a controlled manner, wherein the reactant ions react well with most analytes to form adduct ions being adducts of the reactant ions and the respective analyte.

Alternatively, the reactant ions differ from I⁻, Br⁻, Cl⁻, CF₃O⁻, NO₃⁻, acetate⁻, NO⁺, NH₄⁺, amine⁺, acetone⁺, ethanol⁺, H₃O⁺ and benzene⁺.

Advantageously, the reactant ions differ from ions of the ligand forming substance. Thus, for example in case the ligand forming substance is ethanol, the reactant ions advantageously differ from ethanol⁺, while in case the ligand forming substance is benzene, the reactant ions advantageously differ from benzene⁺. This has the advantage that the ligand compound ions can be made available in the reaction volume easily in a controlled manner.

Alternatively, however, the reactant ions are the ions of the ligand forming substance.

Preferably, the dopant substance is a molecule. This has the advantage that the dopant substance provides a similar binding behaviour to the reactant ions as most ligand forming substances.

Alternatively, however, the dopant substance is not a molecule. In an example where the dopant substance is not a molecule, the dopant substance is a single atom.

Advantageously, the dopant substance differs from the substance of the reactant ions. Thus, advantageously, the ions of the dopant substance differ from the reactant ions. Consequently, for example in case the reactant ions are ethanol⁺, the dopant substance advantageously differs from ethanol. While in case the reactant ions are benzene⁺, the dopant substance advantageously differs from benzene. The dopant substance differing from the substance of the reactant ions has the advantage that the ligand compound ions can be made available in the reaction volume easily in a controlled manner.

Alternatively, however, the dopant substance is the substance of the reactant ions.

Particular advantageously, the dopant substance is chosen to cause a ligand switching in adducts of reactant ions and ligand forming substance. Thus, the dopant substance is advantageously chosen to form a ligand compound ion and release the ligand forming substance when colliding with an adduct of one of the reactant ions and the ligand forming substance. This has the advantage that an optimal control of the availability of ligand compound ions in the reaction volume is easily obtained and maintained even when the partial pressure of the ligand forming substance in the reaction volume changes. Thus, changes of the partial pressure of the ligand forming substance in the reaction volume do not shift the ratio of pure reactant ions to ligand ions from one of the reactant ions and the ligand forming substance present in the reaction volume. Consequently, the ionisation efficiencies of the chemical ionisation ion source for the different analytes remains constant even when the partial pressure of the ligand forming substance in the reaction volume changes. Therefore, a more precise and more reliable quantification of the analytes in the sample with mass spectrometry is enabled.

Preferably, the dopant substance is one of water, ethanol, methanol, benzene, acetone, acetonitrile (ACN), formic acid, lactic acid and nitric acid or is any other molecule containing an acid, peroxide, alcohol or ketone moiety. Thereby, the dopant substance and the reactant ions provide the higher binding energy when binding together to the ligand compound ions than the binding energy the reactant ions and the ligand forming substance provide when binding together. Thus, in case the ligand forming substance is water and the reactant ions are I⁻, the dopant substance is preferably one of acetone, methanol, acetonitrile (ACN), formic acid, lactic acid and nitric acid because they bind more strongly to Iodide than water. Particular preferable, however, in this case, the dopant substance is acetone because the binding energy of acetone to I⁻ is much closer to the binding energy of water to I⁻ than the binding energy of any of methanol, acetonitrile (ACN), formic acid, lactic acid and nitric acid to Iodide. In case the ligand forming substance is benzene or ethanol and the reactant ions are I⁻, however, the dopant substance is advantageously one of water, methanol, acetone, acetonitrile, formic acid, lactic acid and nitric acid because they bind more strongly to Iodide than ethanol or benzene.

Alternatively, however, the dopant substance differs from water, ethanol, methanol, benzene, acetone, acetonitrile (ACN), formic acid, lactic acid and nitric acid.

Preferably, the sample consists of parts, wherein the parts are atoms or molecules, and the dopant substance consists of parts, wherein the parts are atoms or molecules, wherein at least 1 part of dopant substance is provided in the reaction volume per 10′000′000 parts, particular preferably per 1′000′000 parts, more preferably per 100′000 parts, even more preferably per 1′000 parts, most preferably per 100 parts, of the sample as the ligand compound ions are made available in the reaction volume. Thus, advantageously, the amount of dopant substance provided in the reaction volume as dopant substance or already in the form of the ligand compound ions in the reaction volume is preferably controlled to be more than 1 part of dopant substance per 10′000′000 parts, particular preferably per 1′000′000 parts, more preferably per 100′000 parts, even more preferably per 1′000 parts, most preferably per 100 parts, of the sample that are introduced in the reaction volume. In particular, preferably, the amount of dopant substance provided in the reaction volume as dopant substance or already in the form of the ligand compound ions in the reaction volume is controlled to be at all times during executing the chemical ionisation method according to the invention more than 1 part of dopant substance per 10′000′000 parts, particular preferably per 1′000′000 parts, more preferably per 100′000 parts, even more preferably per 1′000 parts, most preferably per 100 parts, of the sample that are present in the reaction volume. In all these variants, the amount of dopant substance in the reaction volume is advantageously controlled to not exceed 1 part per part of the sample in the reaction volume.

Advantageously, the reactant ions and the dopant substance provide a lower binding energy when binding together than a binding energy the reactant ions and any of the analytes to be analysed provide when binding together. This has the advantage that the analytes cause a ligand switching in the ligand compound ions being adducts of reactant ions and the dopant substance. Thus, an efficient ionisation of the analytes is ensured.

Thus, in a preferred variant, the chemical ionisation method includes the preliminary step of choosing the dopant substance such that the dopant substance provides a lower binding energy when binding together with the reactant ions to the ligand compound ions than the binding energy the reactant ions and the analytes provide when binding together. This advantage is particularly easy achieved in case, before ionising the sample including the analytes to be ionised, specific substances, specific compounds, classes of substances and/or classes of compounds are identified as being of interest and thus as being the analytes to be ionised.

Alternatively, however, this preliminary step of choosing the dopant substance such that the dopant substance provides a lower binding energy when binding together with the reactant ions to the ligand compound ions than the binding energy the reactant ions and the analytes provide when binding together is omitted.

Preferably, in the reaction volume a gas pressure in a range from 1 mbar to 1′000 mbar, particular preferably from 10 mbar to 1′000 mbar, most preferably from 20 mbar to 1′000 mbar, is maintained. This has the advantage that in the collision frequency of reactant ions and analytes in the reaction volume is maximised.

In a preferred variant, in the reaction volume a gas pressure in a range from 1 mbar to 500 mbar, particular preferably from 10 mbar to 500 mbar, most preferably from 20 mbar to 500 mbar, is maintained. This has the advantage that in the collision frequency of reactant ions and analytes in the reaction volume is optimised while at the same time, the likelihood of the reactant ions binding with the ligand forming substance is further reduced.

In a further preferred variant, in the reaction volume a gas pressure in a range from 1 mbar to 100 mbar, particular preferably from 10 mbar to 100 mbar, most preferably from 20 mbar to 100 mbar, is maintained. This has the advantage that in the collision frequency of reactant ions and analytes in the reaction volume is optimised while at the same time, the likelihood of the reactant ions binding with the ligand forming substance is further reduced.

Alternatively, however, the gas pressure in the reaction volume is not maintained in any one of the before mentioned ranges.

Preferably, a temperature in the reaction volume is constantly maintained within a bandwidth of 10 degrees Celsius, particular preferably within a bandwidth of 5 degrees Celsius, most preferably within a bandwidth of 10 degrees Celsius, during executing the chemical ionisation method. This has the advantage that in the reaction volume, a ratio of pure reactant ions to ligand compound ions is maintained stable such that the ionisation efficiencies of the chemical ionisation ion source for the different analytes remains even more constant, enabling an even more precise and more reliable quantification of the analytes in the sample with mass spectrometry. Thereby, the respective bandwidth is advantageously maintained at a desired temperature. Thus, the efficiency of the ionisation of the analytes can be optimised by choosing the desired temperature, while maintaining the temperature within the respective bandwidth at this desired temperature, the ionisation efficiencies of the chemical ionisation ion source for the different analytes remains even more constant.

Alternatively, however, the temperature in the reaction volume is not constantly maintained within a bandwidth of 10 degrees Celsius.

Independent of whether during executing the chemical ionisation method, the temperature in the reaction volume is constantly maintained within a bandwidth of 2 degrees Celsius, within a bandwidth of 1 degree Celsius, or not, the temperature in the reaction volume is advantageously constantly maintained below 200° C. This has the advantage that fragmentation and adduct dissociation can be maintained at an acceptable level, while the analytes can even include low volatility compounds. In case it is known, intended or accepted that the analytes include low volatility compounds, the temperature in the reaction volume is advantageously maintained at at least 40° C. in order to have an optimal ionisation efficiency for ionising the low volatility compounds.

In a preferred variant, the temperature in the reaction volume is constantly maintained below 40° C. This has the advantage that fragmentation and adduct dissociation are maintained at a very low level. This is particular advantageous in case the analytes do not include low volatility compounds.

In either case, the temperature in the reaction volume is preferably constantly maintained above 0° C. This has the advantage that freezing of the used equipment is prevented.

In a preferred variant, the temperature in the reaction volume is constantly maintained in a temperature range between 15° C. and 100° C., particular preferably between 25° C. and 100° C., most preferably between 40° C. and 100° C. This has the advantage that the efficiency of the ionisation of the analytes is optimised while at the same time, fragmentation and adduct dissociation of the analytes are maintained at a very low level.

Alternatively to these variants, the temperature in the reaction volume is not maintained within these limits. Thus, the temperature in the reaction volume can at 0° C. or below or at 200° C. or above.

Advantageously, the chemical ionisation method according to the invention is used in a method for mass analysing analytes in a sample including the analytes. Thus, in a method for mass analysing analytes in a sample including the analytes, the sample including the analytes is ionised with the chemical ionisation method according to the invention and the resulting ions are transferred to a mass analyser and mass analysed with the mass analyser in order to mass analyse the analytes. Thereby, advantageously, the analytes to be mass analysed are the analytes to be ionised mentioned above in the context of the chemical ionisation method according to the invention.

This method for mass analysing analytes in a sample including the analytes has the advantage a precise and reliable quantification of the analytes in the sample with mass spectrometry is enabled.

Advantageously, the resulting ions are separated according to their mobility in a drift chamber before being mass analysed with the mass analyser in order to mass analyse the analytes. This has the advantage that an improved analysis of the analytes in the sample is enabled. Alternatively, however, the method for mass analysing analytes goes without such a separation of the resulting ions according to their mobility.

Advantageously, a chemical ionisation ion source includes an ion molecule reactor according to the invention for ionising a sample including analytes to be ionised with the chemical ionisation method according to the invention, wherein the chemical ionisation ion source includes either a reactant ion ion source for ionising the reactant to reactant ions or a ligand compound ion ion source for ionising the ligand compound to ligand compound ions for making the ligand compound ions available in the reaction volume.

Advantageously, the chemical ionisation ion source includes a control unit adapted for controlling the chemical ionisation ion source and adapted for executing the chemical ionisation method according to the invention. Alternatively, however, the chemical ionisation ion source may go without such a control unit.

In case the chemical ionisation ion source includes a reactant ion ion source, the reactant ion ion source is advantageously a laser ablation ion source, an electron ion source, electrospray ion source, an ultraviolet ion source, a spark discharge ion source, an inductively coupled plasma ion source or a microwave induced plasma ion source. This has the advantage that a reliable supply of reactant ions can be ensured. Alternatively, however, the reactant ion ion source differs from these types of ion sources.

In case the chemical ionisation ion source includes a ligand compound ion ion source, the ligand compound ion ion source is advantageously an ion source based on a soft ionisation method in order to reduce fragmentation of the ligand compound during the ionisation of the ligand compound to ligand compound ions. Thus, the ligand compound ion ion source is advantageously an electrospray ion source or an matrix-assisted laser desorption ionisation ion source (MALDI). Alternatively, however, the ligand compound ion ion source differs from these types of ion sources.

In case in the chemical ionisation method employed in the chemical ionisation ion source, a gas pressure in one of the above mentioned ranges from is maintained in the reaction volume, the chemical ionisation ion source advantageously includes means for achieving and maintaining the gas pressure in the reaction volume in the respective range. Since the pressure ranges are below the air pressure on ground on earth, the means for achieving and maintaining the gas pressure in the reaction volume is advantageously a vacuum pump or at least a connection for connecting the chemical ionisation ion source to a vacuum system which is for example readily available in may scientific laboratories. The chemical ionisation ion source can however as well go without such means for achieving and maintaining the gas pressure in the reaction volume in the respective range.

In case in the chemical ionisation method employed in the chemical ionisation ion source, the temperature in the reaction volume is constantly maintained within a bandwidth of 2 degrees Celsius or of 1 degree Celsius and/or in case the temperature is constantly maintained in one of the above described temperature ranges, the chemical ionisation ion source advantageously includes means for achieving and maintaining the temperature in the reaction volume within the respective bandwidth and/or range. In an example, the means for achieving and maintaining the temperature in the reaction volume within the respective bandwidth and/or range are a temperature control unit connected to a temperature sensor and connected to a heater for heating the reaction volume for achieving and maintaining the temperature in the reaction volume within the respective bandwidth and/or range. The chemical ionisation ion source can however as well go without such means for achieving and maintaining the temperature in the reaction volume within the respective bandwidth and/or range.

Advantageously, a mass spectrometer for mass analysing analytes in a sample including the analytes with the method for mass analysing analytes in a sample including the analytes which includes the chemical ionisation ion source for ionising the sample including the analytes to resulting ions, wherein the mass spectrometer further includes a mass analyser for mass analysing the resulting ions in order to mass analyse the analytes, wherein the mass analyser is fluidly coupled to the chemical ionisation ion source for receiving the resulting ions.

Advantageouly, the mass spectrometer includes a control unit adapted for controlling the mass spectrometer and for controlling the mass spectrometer to execute for the method for mass analysing analytes in the sample including the analytes. Alternatively, however, the mass spectrometer may go without such a control unit.

Advantageously, the mass spectrometer includes an ion mobility separation cell fluidly coupled between the chemical ionisation ion source and the mass analyser for separating the resulting ions received from the chemical ionisation ion source according to their mobility before mass analysing the resulting ions. This has the advantage that an improved analysis of the analytes in the sample is enabled. Alternatively, however, the mass spectrometer goes without such an ion mobility separation cell.

Other advantageous embodiments and combinations of features come out from the detailed description below and the entirety of the claims.

### BRIEF DESCRIPTION OF THE DRAWINGS

The drawings used to explain the embodiments show:

FIG. 1 a simplified schematic view of an ion molecular reactor according to the invention for ionising a sample including analytes to be ionised with the method according to the invention, in particular for use with a mass spectrometer,

FIG. 2 a simplified schematic view of a chemical ionisation ion source which includes the ion molecule reactor shown in FIG. 1 for ionising a sample including analytes to be ionised with the method according to the invention,

FIG. 3 a simplified schematic view of a variant of the chemical ionisation ion source which includes the ion molecule reactor shown in FIG. 1 for ionising a sample including analytes to be ionised with the method according to the invention,

FIG. 4 a simplified schematic view of a mass spectrometer for mass analysing analytes in a sample including the analytes, the mass spectrometer including the chemical ionisation ion source shown in FIG. 2,

FIG. 5a, b, c calculated diagrams showing the ratios of iodide ions (I⁻) as reactant ions and ligand ions of these reactant ions (I⁻) formed with water (I(H₂O)⁻, I(H₂O)₂⁻ and I(H₂O)₃⁻, respectively) in dependence of the partial gas pressure of water (pH2O) in the ion molecule reactor (IMR) i.e. the reaction volume, at a temperature of 25° C.,

FIG. 6 the same curves as FIG. 5a, calculated for a total gas pressure of 50 mbar at 25° C. in the reaction volume and a measurement of nitric acid, acrylic acid and formic acid in laboratory air at 25° C. and 50 mbar total gas pressure in the reaction volume at different partial gas pressures of water in the reaction volume, normalised to the amount of nitric acid, acrylic acid and formic acid measured in completely dry conditions where the partial gas pressure of water in the reaction volume was zero,

FIG. 7a, b measured diagrams for illustrating the chemical ionisation method according to the invention at a total gas pressure of 50 mbar in the reaction volume and at a temperature of 25° C. in the reaction volume, with a acetone as dopant substance,

FIG. 8a, b, c measured diagrams for illustrating the chemical ionisation method according to the invention at a total gas pressure of 50 mbar in the reaction volume and at a temperature of 25° C. in the reaction volume, with methanol as dopant substance,

FIG. 9a, b measured diagrams for illustrating the chemical ionisation method according to the invention at a total gas pressure of 50 mbar in the reaction volume and at a temperature of 25° C. in the reaction volume, with acetonitrile (ACN) as dopant substance, and

FIG. 10 the same two diagrams as FIG. 6, wherein the lower diagram of FIG. 10, however, additionally the same measurement of nitric acid, formic acid and acrylic acid in laboratory air performed under the same conditions but by using the chemical ionisation method according to the invention is shown with the data points being shown as filled points.

In the figures, the same components are given the same reference symbols.

### PREFERRED EMBODIMENTS

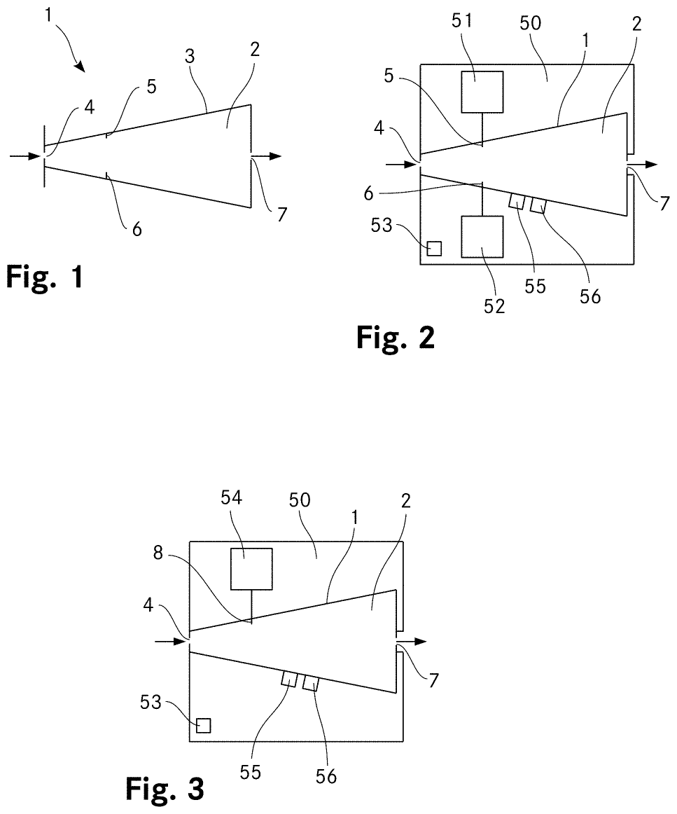

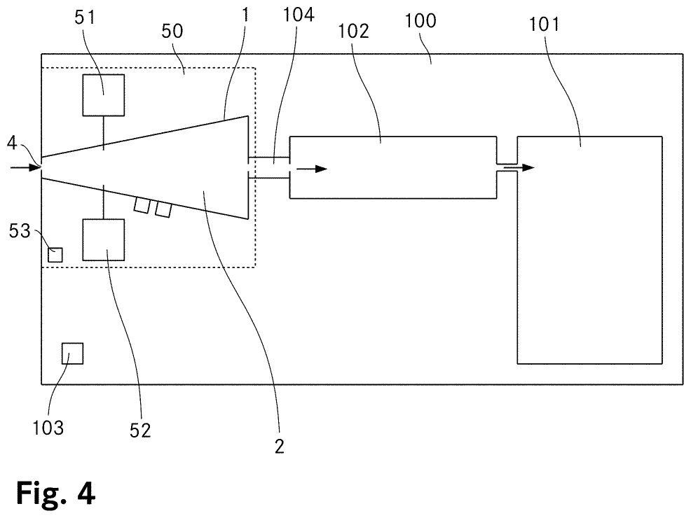

FIG. 1 shows a simplified schematic view of an ion molecular reactor 1 according to the invention for ionising a sample including analytes to be ionised with the chemical ionisation method according to the invention, in particular for use with a mass spectrometer 100 (see FIG. 4). This ion molecular reactor 1 includes a reaction volume 2 which is defined by a chamber 3 of the ion molecule reactor 1. The reaction volume 2 is adapted for ionising inside the reaction volume 2 the sample including the analytes to be ionised by adduct ionisation, which is a type of chemical ionisation. Inside of the reaction volume 2, ligand compound ions formed from reactant ions and a dopant substance can be made available to react with the sample including the analytes to form adduct ions and a neutral byproduct, the adduct ions including ionised analytes being adducts of the reactant ions and the respective analytes.

The ion molecule reactor 1 includes a sample inlet 4 for introducing the sample including the analytes into the reaction volume 2 and two reactant inlets 5, 6. A first one of these two reactant inlets 5 is for introducing reactant ions into the reaction volume 2, while a second one of these two reactant inlets 6 is for introducing a dopant substance into the reaction volume 2 for forming ligand compound ions with the reactant ions in the reaction volume 2 in order to make available the ligand compound ions in the reaction volume 2. Thus, the ion molecule reactor 1 includes two reactant inlets 5, 6 for introducing at least one substance into the reaction volume 2 for making available the ligand compound ions inside the reaction volume 2. Furthermore, the ion molecule reactor 1 includes an outlet 7 for letting out the adduct ions from the reaction volume 2 and for enabling transferring the adduct ions from the reaction volume 2 to the mass analyser 101 of the mass spectrometer 100, when the ion molecule reactor 1 is used in the mass spectrometer 100.

FIG. 2 shows a simplified schematic view of a chemical ionisation ion source 50 which includes the ion molecule reactor 1 shown in FIG. 1 for ionising a sample including analytes to be ionised with the chemical ionisation method according to the invention, wherein the chemical ionisation ion source 50 further includes a reactant ion ion source 51 for ionising a reactant to reactant ions. This reactant ion ion source 51 is an ultraviolet ion source and is fluidly coupled to the first one of the two reactant inlets 5 of the ion molecule reactor 1 for introducing the reactant ions from the reactant ion ion source 51 into the reaction volume 2. The chemical ionisation ion source 50 furthermore includes a reservoir 52 of dopant substance fluidly coupled to the second one of the two reactant inlets 6 of the ion molecule reactor 1 for introducing the dopant substance in the reaction volume 2 in order to make the ligand compound ions available in the reaction volume 2.

Additionally, the chemical ionisation ion source 50 includes means 55 for achieving and maintaining a desired temperature in the reaction volume within a desired bandwidth. These means 55 are a temperature control unit with to a temperature sensor sensing the temperature in the reaction volume 2 and a heater for heating the reaction volume 2 for achieving and maintaining the temperature in the reaction volume within the respective bandwidth and range.

Furthermore, the chemical ionisation ion source 50 includes means 56 for achieving and maintaining the gas pressure in the reaction volume in the desired range. Since in the chemical ionisation ion source 50, the desired pressure ranges are below the air pressure on ground on earth and since the chemical ionisation ion source 50 is intended to be used on ground, the means for achieving and maintaining the gas pressure in the reaction volume is simply a vacuum pump.

In a variant shown in FIG. 3, the chemical ionisation ion source 50 includes a ligand compound ion ion source 54 instead of the reactant ion ion source 51. In this case, a ligand compound formed of the reactant and the dopant substance is ionised by the ligand compound ion ion source 54 to ligand compound ions. Thus, in this case, the ion molecular reactor 1 includes only one reactant inlet 8 which is fluidly coupled to the ligand compound ion ion source 54 for introducing the ligand compound ions from the ligand compound ion ion source 54 into the reaction volume 2 in order to make the ligand compound ions available in the reaction volume 2.

In both the cases shown in FIGS. 2 and 3, the chemical ionisation ion source 50 further includes a control unit 53 adapted for controlling the chemical ionisation ion source 50 and adapted for executing the chemical ionisation method according to the invention.

FIG. 4 shows a simplified schematic view of a mass spectrometer 100 for mass analysing analytes in a sample including the analytes. This mass spectrometer 100 includes the chemical ionisation ion source 50 shown in FIG. 2 for ionising the sample including the analytes to resulting ions. The mass spectrometer 100 further includes a mass analyser 101 for mass analysing the resulting ions in order to mass analyse the analytes. This mass analyser 101 is in the present embodiment a time of flight mass analyser. However, the mass analyser 101 can as well be any other type of mass analyser like for example a quadrupole mass analyser. In the mass spectrometer 100 shown in FIG. 4, the mass analyser 101 is fluidly coupled to the chemical ionisation ion source 50 for receiving the resulting ions. Thus, the mass spectrometer 100 is for mass analysing the analytes in the sample including the analytes with a method for mass analysing the analytes in the sample including the analytes where the sample including the analytes is ionised with the method according to the invention and the resulting ions are transferred to the mass analyser 101 and mass analysed with the mass analyser 101 in order to mass analyse the analytes.

The mass spectrometer 100 further includes a ion mobility separation cell 102 fluidly coupled between the chemical ionisation ion source 50 and the mass analyser 101 for separating the resulting ions received from the chemical ionisation ion source 50 according to their mobility before mass analysing the resulting ions in the mass analyser 101. Thus, in the method for mass analysing the analytes in the sample including the analytes, the resulting ions are separated according to their mobility in the ion mobility separation cell 102 before being mass analysed with the mass analyser 101 in order to mass analyse the analytes. In order to pass the resulting ions in a pulsed manner through the ion mobility separation cell 102, the mass spectrometer 100 includes an ion trap 104 arranged downstream of the chemical ionisation ion source 50 and upstream of the ion mobility separation cell 102. In this ion trap 104, the resulting ions received from the chemical ionisation ion source 50 are collected and released in pulses to be passed through the ion mobility separation cell 102 for being separated according to their mobility.

For the sake of completeness, it is mentioned here that the mass spectrometer 100 includes a control unit 103 adapted for controlling the mass spectrometer 100 and for controlling the mass spectrometer 100 to execute the methods described in the present text. In FIG. 4, this control unit 103 is shown schematically as a square in the mass spectrometer 100. However, the control unit 103 may as well be a separate computer connected to the rest of the mass spectrometer 100. Thereby, the control unit 103 may directly control the chemical ionisation ion source 50 or may control a control unit 53 of the chemical ionisation ion source 50. Since the control units 103 adapted for controlling a mass spectrometer are well known in the art, the control unit 103 of the mass spectrometer 100 shown in FIG. 4 is not further explained here.

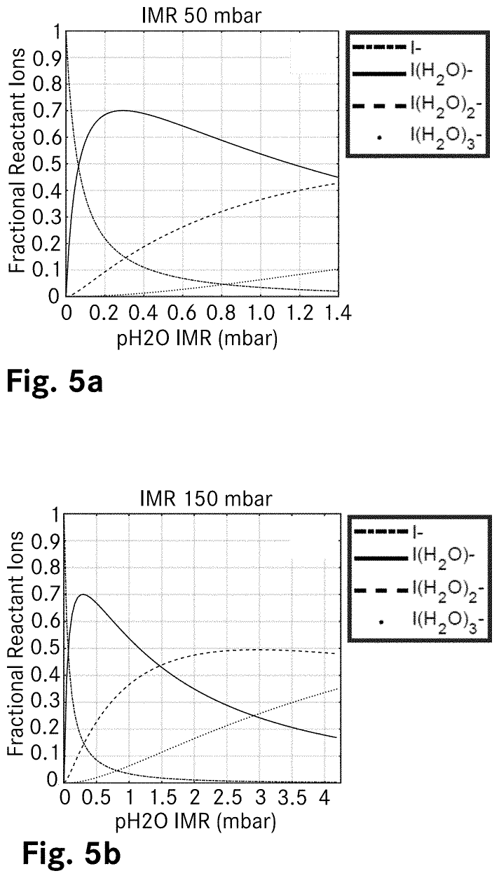

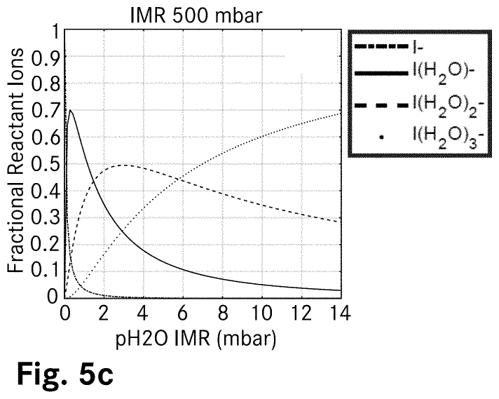

FIGS. 5a, 5b and 5c show calculated diagrams showing the ratios of iodide ions (I⁻) as reactant ions and ligand ions of these reactant ions (I⁻) formed with water (I(H₂O)⁻, I(H₂O)₂⁻ and I(H₂O)₃⁻, respectively) in dependence of the partial gas pressure of water (pH2O) in the ion molecule reactor (IMR) i.e. the reaction volume, at a temperature of 25° C. Thereby, the partial gas pressure of water in the reaction volume is shown in mbar on the x-axis, while the amounts of reactant ions (I⁻) and ligand ions are shown on the y-axis in units of their fraction of the total number of iodide in the reaction volume. For this reason, the y-axis is labelled “Fractional Reactant Ions” on the y-axis, while the partial gas pressure of water in the reaction volume is shown on the x-axis.

The diagram shown in FIG. 5a is calculated for a total gas pressure of 50 mbar in the reaction volume. Thereby, the partial gas pressure of water on the x-axis reaches from 0 mbar to 1.4 mbar, which is from zero to 2.8% of the total gas pressure in the reaction volume. The diagram shown in FIG. 5b is calculated for a total gas pressure of 150 mbar in the reaction volume. Thereby, the partial gas pressure of water on the x-axis reaches from 0 mbar to 4.2 mbar, which is as well from zero to 2.8% of the total gas pressure in the reaction volume. The diagram shown in FIG. 5c has been calculated for a total gas pressure of 500 mbar in the reaction volume. Thereby, the partial gas pressure of water on the x-axis reaches from 0 mbar to 14 mbar, which is as well from zero to 2.8% of the total gas pressure in the reaction volume.

The diagrams shown in FIGS. 5a, 5b and 5c illustrate on the example of iodide ions (I⁻) as reactant ions, how strongly the presence of water as ligand forming substance in the reaction volume influences the ratios between the pure reactant ions (I⁻) and the different ligand ions (I(H₂O)⁻, I(H₂O)₂⁻, and I(H₂O)₃⁻, respectively) formed from the reactant ions and the ligand forming substance. As illustrated, in case the sample includes a varying content of water as ligand forming substance, these ratios change considerably as the content of water varies. Since the pure reactant ions (I⁻) and the different types of ligand ions (I(H₂O)⁻, I(H₂O)₂⁻, and I(H₂O)₃⁻, respectively) provide a different likelihood for reacting with an analyte to form an adduct ion of one reactant ion and one analyte and in case of the ligand ions to form an adduct ion of one reactant ion and one analyte besides a neutral byproduct, the ionisation efficiencies of a prior art chemical ionisation ion source for different analytes chances dramatically as the amount of ligand forming substance changes in the sample.

As visible from FIGS. 5a, 5b and 5c, a total gas pressure of 50 mbar in the reaction volume and a partial gas pressure of water between 0.2 mbar and 0.4 mbar in the reaction volume provide the least changes in the ligand ions in particular in the ratio of pure reactant ions (I⁻) and the first ligand ions I(H₂O)⁻. For this reason, the prior art it teaches to aim at such conditions in the reaction volume in order to improve the quantitative results of the mass analysis of the analytes in the sample. This can be achieved by maintaining the total gas pressure in the reaction volume low enough while continuously adding some of the ligand forming substance to the reaction volume to achieve and maintain in the reaction volume a certain minimal partial gas pressure of the ligand forming substance, the minimal partial gas pressure being in a range where the sensitivity of reactant ion□adduct ionisation to many compounds shifts more gradually when the amount of ligand forming substance in the sample changes.

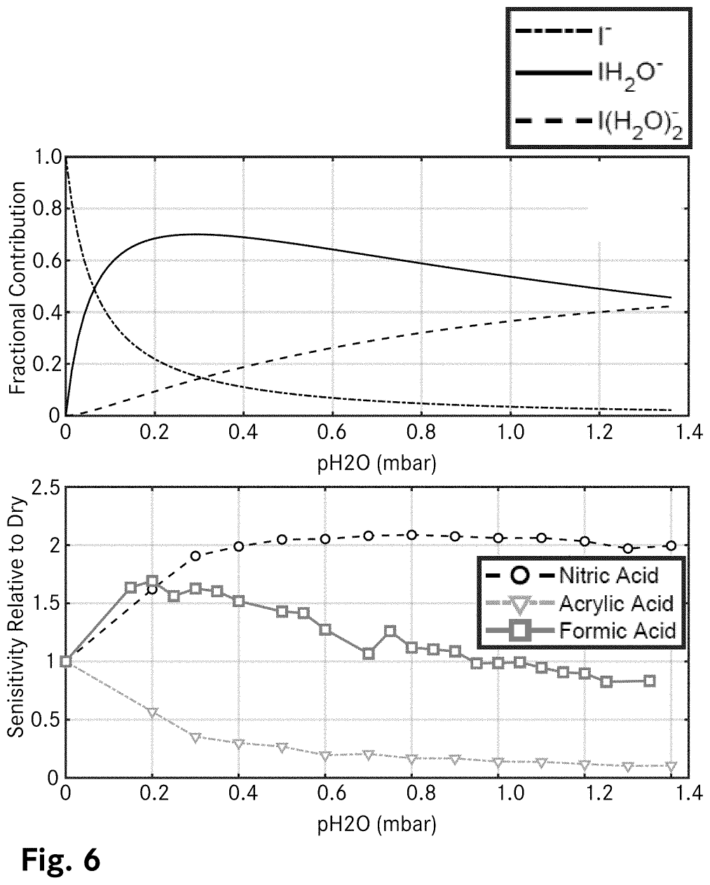

The upper diagram in FIG. 6 shows the same curves as FIG. 5a, calculated for a total gas pressure of 50 mbar at 25° C. in the reaction volume. In order to illustrate the changes of the sensitivity of reactant ion-adduct ionisation in the prior art chemical ionisation methods, the lower diagram of FIG. 6 shows a measurement of nitric acid, acrylic acid and formic acid in laboratory air at 25° C. and 50 mbar total gas pressure in the reaction volume at different partial gas pressures of water in the reaction volume, normalised to the amount of nitric acid, acrylic acid and formic acid measured in completely dry conditions where the partial gas pressure of water in the reaction volume was zero. The measurement has been performed by mass spectrometry, wherein the sample of laboratory air with the included analytes nitric acid, acrylic acid and formic acid was ionised with a prior art chemical ionisation method using iodide ions (I⁻). In order to simulate the different amounts of water as ligand forming substance in the sample, water vapour was introduced into the reaction volume for achieving the different partial gas pressures of water in the reaction volume.

As can be seen from the lower diagram in FIG. 6, the sensitivity for ionising nitric acid with the prior art chemical ionisation method increases by 100% from zero to 0.4 mbar partial gas pressure of water in the reaction volume. At the same time, the sensitivity for ionising acrylic acid decreases by about 70% from zero to 0.4 mbar partial gas pressure of water in the reaction volume and even decreases further towards higher partial gas pressures of water in the reaction volume. Even more, the sensitivity for ionising formic acid increases by about 70% from zero to 0.2 mbar partial gas pressure of water in the reaction volume and then decreases again at higher gas pressures of waters and even drops below the sensitivity achieved at zero partial gas pressure of water when the partial gas pressure of water in the reaction volume is increased to just above 1 mbar.

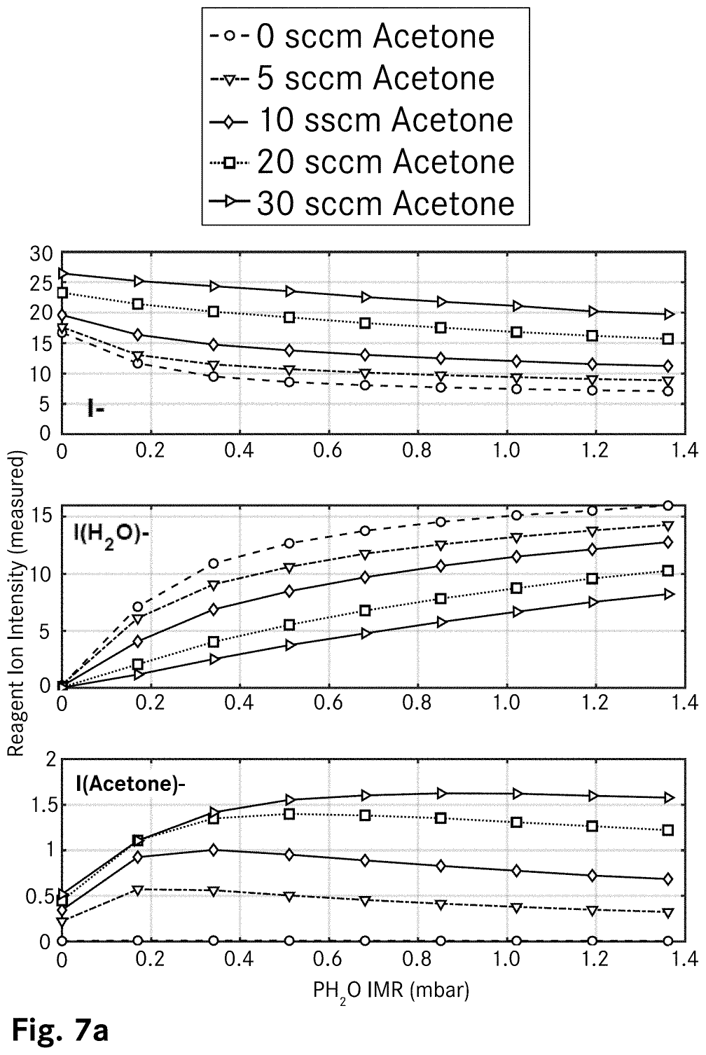

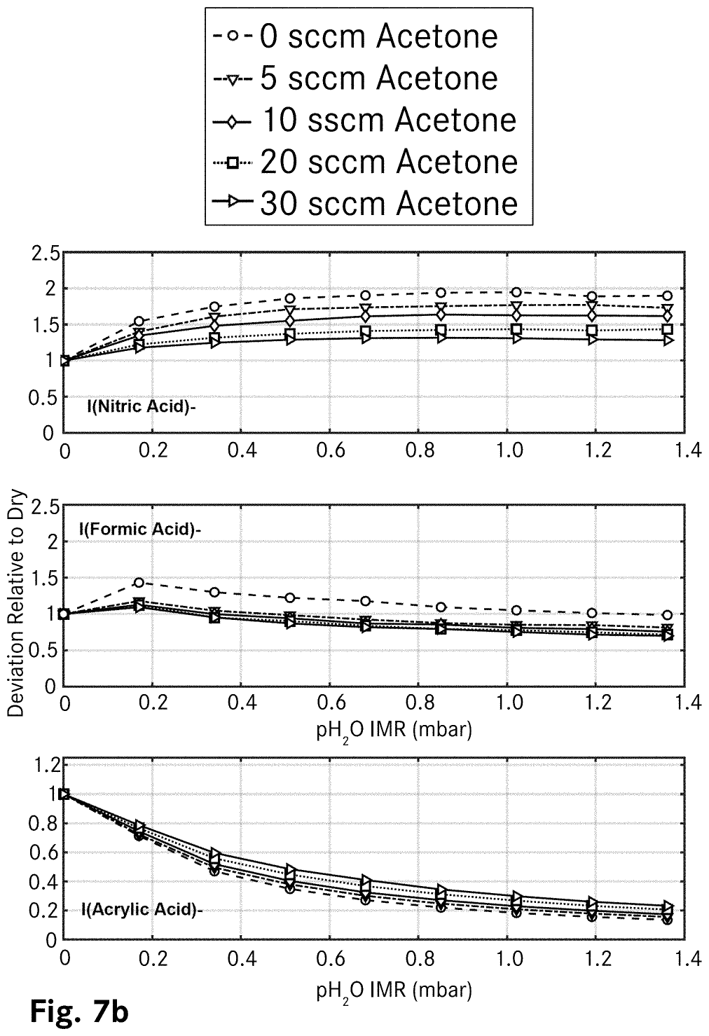

FIGS. 7a and 7b show measured diagrams for illustrating the chemical ionisation method according to the invention at a total gas pressure of 50 mbar in the reaction volume and at a temperature of 25° C. in the reaction volume (2). In this example, again, iodide ions (I⁻) are the reactant ions and water is the ligand forming substance. In order to simulate different amounts of ligand forming substance in the sample, water vapour was introduced into the reaction volume (2) for achieving the different partial gas pressures of water in the reaction volume (2). In contrast to the prior art, a dopant substance has additionally been introduced into the reaction volume (2) which reacts with the reactant ions and forms ligand compound ions in order to make ligand compound ions available in the reaction volume (2).

In the example of FIGS. 7a and 7b, the dopant substance is acetone. Thereby, curves measured for different amounts of dopant substance introduced into the reaction volume measured in sccm are shown. Again, the partial gas pressure of water in the reaction volume is shown on the x-axis of the three diagrams. In the top diagram of FIG. 7a, the amounts of pure reactant ions (I⁻) measured is shown on the y-axis in arbitrary units. In the centre diagram of FIG. 7a, the amounts of the first ligand ions I(H₂O)⁻ measured is shown on the y-axis in the same arbitrary units. And in the lower diagram of FIG. 7a, the amounts of the ligand compound ions formed from the dopant substance acetone measured is shown on the y-axis in the same arbitrary units.

As can be seen from FIG. 7a, with increasing amount of the dopant substance acetone in the reaction volume (2), the ratio of ligand ions to ligand compound ions shifts in the favour of the ligand compound ions.

In FIG. 7b, diagrams are shown where the air in the laboratory has been sampled for nitric acid (top diagram), formic acid (centre diagram) and acrylic acid (lower diagram) by mass spectrometry, again with the different partial gas pressures of water in the reaction volume (2) and for different amounts of dopant substance introduced into the reaction volume (2). Thereby, in all three diagrams shown in FIG. 7b, the y-axis is normalised to the amount of the respective acid measured in the dry, i.e. at zero partial gas pressure of water.

As can be seen from FIG. 7b, with iodide ions (I⁻) as reactant ions and acetone as dopant substance, the dependency of the ionisation efficiency on water as changing ligand forming substance in the sample is reduced for nitric acid, formic acid and acrylic acid with the chemical ionisation method according to the invention. The reason for this effect is that acetone provides a slightly higher binding energy when binding to the iodide ions (I⁻) than water provides when binding to the iodide ions (I⁻).

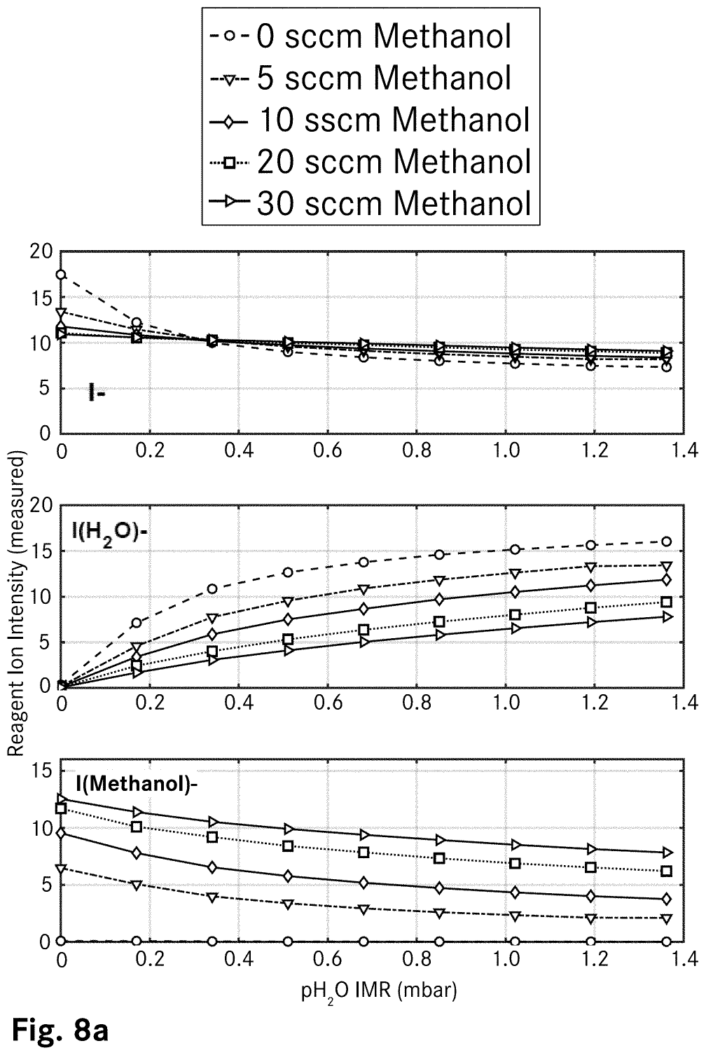

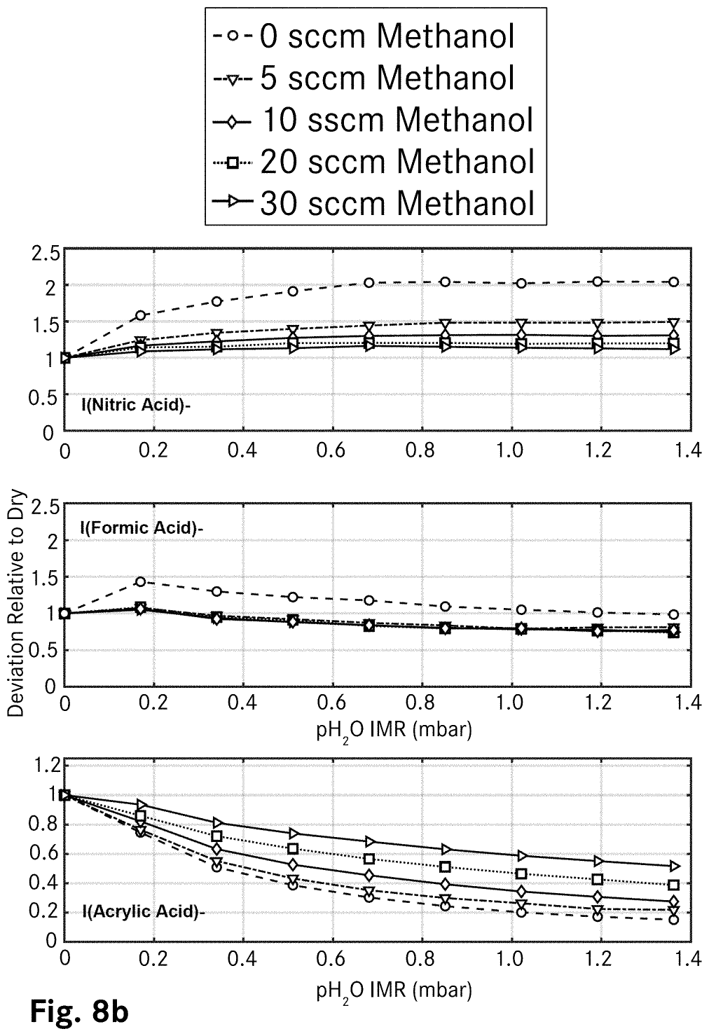

FIGS. 8a and 8b show the same diagrams as FIGS. 7a and 7b measured essentially under the same conditions. However, in FIGS. 8a and 8b, methanol has been used as dopant substance instead of acetone. As can be seen, the dependency of the ionisation efficiency on water as changing ligand forming substance in the sample is reduced even further for nitric acid, formic acid and acrylic acid with the chemical ionisation method according to the invention in case methanol is used as dopant substance. The reason for this effect is that methanol provides a higher binding energy when binding to the iodide ions (I⁻) than acetone provides when binding to the iodide ions (I⁻) and than water provides when binding to the iodide ions (I⁻).

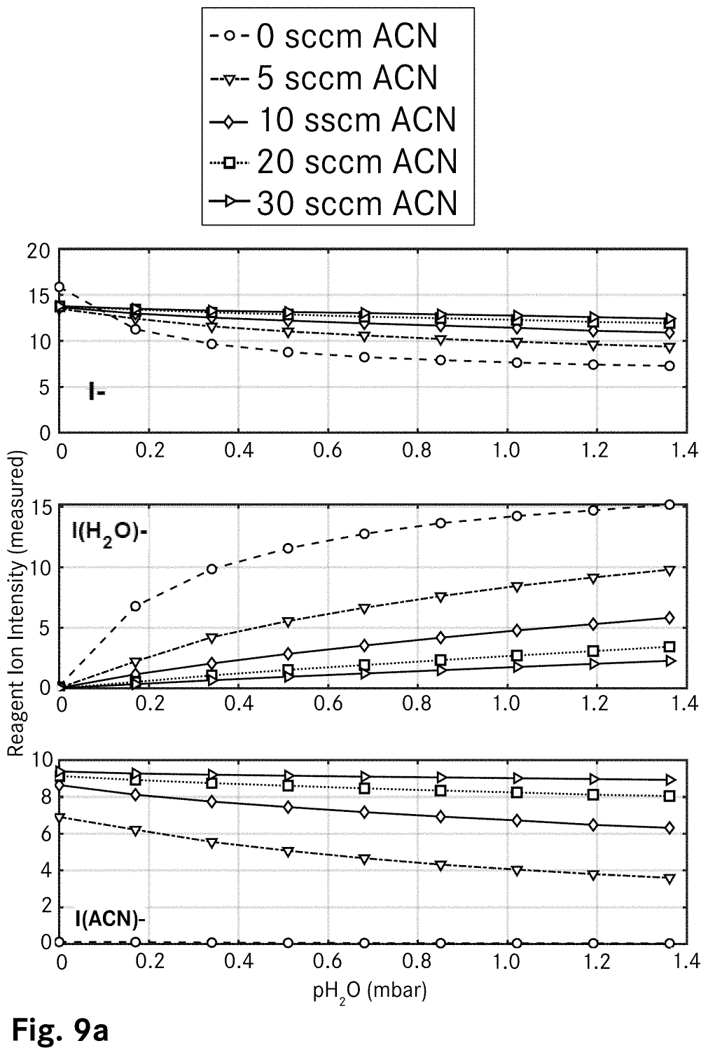

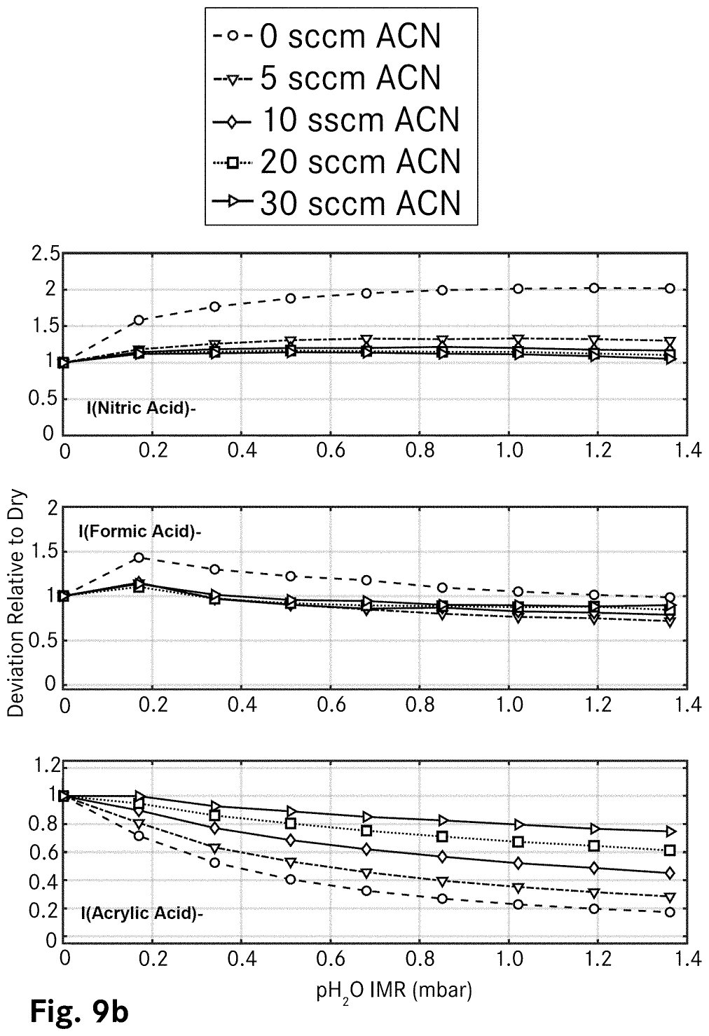

FIGS. 9a and 9b show the same diagrams as FIGS. 7a and 7b and FIGS. 8a and 8b, respectively, measured essentially under the same conditions. However, in FIGS. 9a and 9b, acetonitrile (ACN) has been used as dopant substance instead of acetone or methanol. As can be seen, the dependency of the ionisation efficiency on water as changing ligand forming substance in the sample is roughly the same for nitric acid and formic acid as in case methanol is used as dopant substance (see FIG. 8b). However, the dependency of the ionisation efficiency on water as changing ligand forming substance in the sample is reduced further for acrylic acid with the chemical ionisation method according to the invention in case acetonitrile (ACN) is used as dopant substance. The reason for this effect is that acetonitrile (ACN) provides a higher binding energy when binding to the iodide ions (I⁻) than methanol provides when binding to the iodide ions (I⁻), than acetone provides when binding to the iodide ions (I⁻) and than water provides when binding to the iodide ions (I⁻).

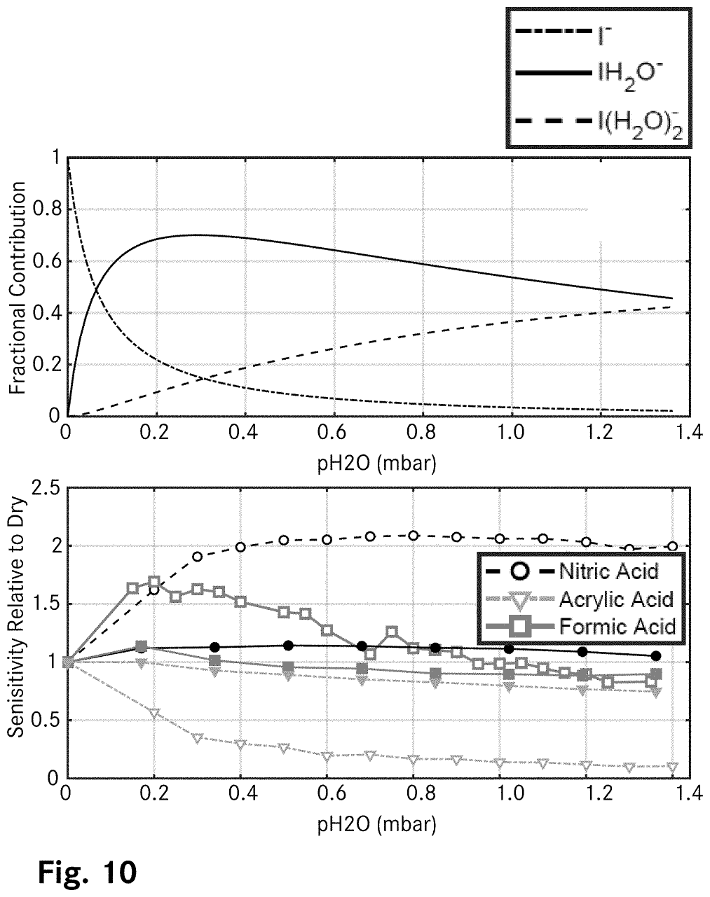

FIG. 10 shows the same two diagrams as FIG. 6. In the lower diagram of FIG. 10, however, additionally the same measurement of nitric acid, formic acid and acrylic acid in laboratory air performed under the same conditions but by using the chemical ionisation method according to the invention is shown with the data points being shown as filled points. In this additionally shown measurement, a flow of 30 sccm of acetonitrile (ACN) as dopant substance was introduced into the reaction volume (2) for making available the ligand compound ions in the reaction volume (2).

As can be seen from the lower diagram of FIG. 10, the chemical ionisation method according to the invention enables a considerably more precise and more reliable quantification of the analytes in the sample with mass spectrometry. The sensitivity for ionising nitric acid, formic acid and acrylic acid no longer varies in the order of 100% with changing water content in the sample. Rather, the changes of sensitivity for changing water content is reduced to 20% or even lower.

The invention is not limited to the examples illustrated in the context of the Figures. For example, the invention is not limited to iodide ions (I⁻) as reactant ions. Any of of I⁻, Br⁻, Cl⁻, CF₃O⁻, NO₃⁻, acetate⁻, NO⁺, NH₄⁺, amine⁺, acetone⁺, ethanol⁺, H₃O⁺ and benzene⁺ can be used as reactant ions. Even more, the invention is not limited to these reactant ions. Other reactant ions can be used as well. Furthermore, the dopant substance is not limited to acetone, methanol and acetonitrile (ACN). Any dopant substance of water, ethanol, methanol, benzene, acetone, acetonitrile (ACN), formic acid, lactic acid and nitric acid can be used. Even more, the invention is not limited to these dopant substances. Rather, any other dopant substance can be used as well. Additionally, the ligand forming substance is not required to be water as used in the examples illustrated in the context of the Figures. The ligand forming substance can by any one of water, ethanol, benzene, nitric acid and acetic acid. Even more, the invention is not limited to these ligand forming substances. Rather, any other ligand forming substance can be used as well. Important for the invention is only that the reactant ions and the dopant substance provide the higher binding energy when binding together to the ligand compound ions than the binding energy the reactant ions and a ligand forming substance provide when binding together. The chemical ionisation method according to the invention is particular advantageous, if at least traces of the ligand forming substance are present in the sample and the amount of ligand forming substance is likely to vary during one measurement or between two or more measurements which should be compared quantitatively afterwards. Thus, the chemical ionisation method according to the invention is particular advantageous in case the sample consists of parts and includes at least one part, in particular at least one molecule, of the ligand forming substance per 10′000′000 parts of the sample. Furthermore, the chemical ionisation method according to the invention is advantageous in case the sample consists of parts, wherein the parts are atoms or molecules, and wherein a concentration of the parts of ligand forming substance in the total parts of the sample varies at a rate of at least 10% of the initial concentration of the parts of ligand forming substance in the total parts of the sample within one hour, within one minute or even within one second.

Additionally, the chemical ionisation method according to the invention is particular advantageous in case the sample consists of parts, wherein the parts are atoms or molecules, and the amount of dopant substance provided in the reaction volume as dopant substance or already in the form of the ligand compound ions in the reaction volume is controlled to be at all times during executing the chemical ionisation method according to the invention more than 1 part of dopant substance per 10′000′000 parts of the sample, like for example 1 part per 10′000 parts of the sample, or even 1 part per 100 parts of the sample, that are present in the reaction volume. In the measurement obtained with the chemical ionization method according to the invention shown in the lower diagram of FIG. 10, the total gas pressure in the reaction volume was 50 mbar and the temperature was maintained at 25° C. within a bandwidth of 1 degree Celsius. This was chosen because these parameters are optimal for the measurement obtained with the prior art chemical ionization method which is shown in the diagram as well. In the chemical ionization method according to the invention, the total gas pressure in the reaction volume can be chosen to be higher or lower. In examples, the total gas pressure in the reaction volume is 10 mbar, 30 mbar, 100 mbar, 250 mbar, 500 mbar, 750 mbar and 900 mbar, respectively. Furthermore, the temperature in the reaction volume can be chosen to be higher or lower. In examples, the temperature in the reaction volume is 16° C., 20° C., 30° C., 50° C., 70° C., 100° C., 150° C. and 170° C., respectively.

In summary, it is to be noted that a chemical ionisation method, in particular an adduct ionisation method, and an ion molecule reactor pertaining to the technical field initially mentioned are provided that enable a more precise and more reliable quantification of the analytes in the sample with mass spectrometry.

We claim:

1. A chemical ionisation method, for ionising a sample including analytes to be ionised,
wherein ligand compound ions formed from reactant ions and a dopant substance are made available in a reaction volume,
wherein said sample with said analytes is introduced into said reaction volume to react with said ligand compound ions to form adduct ions and a neutral byproduct, said adduct ions including ionised analytes being adducts of said reactant ions and the respective said analytes,
wherein said reactant ions and said dopant substance provide a higher binding energy when binding together to said ligand compound ions than a binding energy said reactant ions and a ligand forming substance provide when binding together, wherein said ligand forming substance is present at least in traces in said reaction volume when said sample with said analytes react with said ligand compound ions to form said adduct ions and said neutral byproduct.

2. The chemical ionisation method as claimed in claim 1, wherein said sample includes at least traces of said ligand forming substance.

3. The chemical ionisation method as claimed in claim 2, wherein said sample consists of parts and includes at least one part, of said ligand forming substance per 10′000′000 parts, wherein said parts are atoms or molecules.

4. The chemical ionisation method as claimed in claim 1, wherein said ligand forming substance is one of water, ethanol, benzene, nitric acid and acetic acid or is any other molecule containing an acid, peroxide, alcohol or ketone moiety.

5. The chemical ionisation method as claimed in claim 1, wherein said reactant ions are one of I⁻, Br⁻, Cl⁻, CF₃O⁻, NO₃⁻, acetate⁻, NO⁺, NH₄⁺, amine⁺, acetone⁺, ethanol⁺, H₃O⁺ and benzene⁺.

6. The chemical ionisation method as claimed in claim 1, wherein said dopant substance is a molecule.

7. The chemical ionisation method as claimed in claim 1, wherein said dopant substance is one of water, ethanol, methanol, benzene, acetone, acetonitrile, formic acid, lactic acid, nitric acid, or is any other molecule containing an acid, peroxide, alcohol or ketone moiety, and in that said dopant substance and said reactant ions provide said higher binding energy when binding together to said ligand compound ions than said binding energy said reactant ions and said ligand forming substance provide when binding together.

8. The chemical ionisation method as claimed in claim 1, wherein said reactant ions and said dopant substance provide a lower binding energy when binding together than a binding energy said reactant ions and any of said analytes to be analysed provide when binding together.

9. The chemical ionisation method as claimed in claim 1, wherein in said reaction volume a gas pressure in a range from 1 mbar to 1′000 mbar, is maintained.

10. The chemical ionisation method as claimed in claim 1, wherein a temperature in said reaction volume is constantly maintained within a bandwidth of 2 degrees Celsius, during executing said chemical ionisation method.

11. The chemical ionisation method as claimed in claim 1, wherein the temperature in said reaction volume (2) is constantly maintained in a temperature range between 15° and 100° C.

12. A method for mass analysing analytes in a sample including said analytes, wherein said sample including said analytes is ionised with the chemical ionisation method as claimed in claim 1 and the resulting ions are transferred to a mass analyser and mass analysed with said mass analyser in order to mass analyse said analytes.

13. An ion molecule reactor for ionising a sample including analytes to be ionised with the chemical ionisation method according to claim 1, in particular for use with a mass spectrometer, including:
a) a reaction volume adapted for ionising inside said reaction volume (2) said sample including said analytes to be ionised by chemical ionisation,
wherein inside of said reaction volume ligand compound ions formed from reactant ions and a dopant substance can be made available to react with said sample including said analytes to form adduct ions and a neutral byproduct, said adduct ions including ionised analytes being adducts of said reactant ions and the respective said analytes,
b) at least one sample inlet for introducing said sample including said analytes into said reaction volume;
c) at least one reactant inlet for introducing at least one substance into said reaction volume for making said ligand compound ions available inside said reaction volume; and
d) an outlet for letting out said adduct ions from said reaction volume.

14. A chemical ionisation ion source including an ion molecule reactor according to claim 13 for ionising a sample including analytes to be ionised with the chemical ionisation method according to claim 1,
wherein said chemical ionisation ion source includes either a reactant ion ion source for ionising the reactant to reactant ions or a ligand compound ion ion source for ionising the ligand compound to ligand compound ions for making said ligand compound ions available in said reaction volume.

15. A mass spectrometer for mass analysing analytes in a sample including said analytes with the method as claimed in claim 12,
wherein said mass spectrometer including a chemical ionisation ion source according to claim 14 for ionising said sample including said analytes to resulting ions, said mass spectrometer including a mass analyser for mass analysing said resulting ions in order to mass analyse said analytes, wherein said mass analyser is fluidly coupled to said chemical ionisation ion source for receiving the resulting ions.

16. The chemical ionisation method as claimed in claim 2, wherein said sample consists of parts and includes at least one molecule of said ligand forming substance per 10′000′000 parts, wherein said parts are molecules.

17. The chemical ionisation method as claimed in claim 1, wherein in said reaction volume a gas pressure in a range from 10 mbar to 1′000 mbar is maintained.

18. The chemical ionisation method as claimed in claim 1, wherein in said reaction volume a gas pressure in a range from 20 mbar to 1′000 mbar is maintained.

19. The chemical ionisation method as claimed in claim 1, wherein the temperature in said reaction volume is constantly maintained in a temperature range between 25° C. and 100° C.

20. The chemical ionisation method as claimed in claim 1, wherein the temperature in said reaction volume is constantly maintained in a temperature range between 40° C. and 100° C.
